(19) United States
(12) Patent Application Publication
(10) Pub. No.: US 2003/0108476 A1
(43) Pub. Date: Jun. 12, 2003

(54) Method for producing a polycrystalline diamond element and element produced according to said method

(76) Inventors: Eckhard Woerner, Freiburg (DE); Christoph Wild, Denzlingen (DE); Peter Koidl, Dendingen (DE)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/240,185

(22) PCT Filed: Mar. 14, 2001
(86) PCT No.: PCT/EP01/02838

(30) Foreign Application Priority Data
Mar. 29, 2000 (DE) 10015729.7

(51) Int. Cl. B29D 11/00; B29C 41/42

(52) U.S. Cl. 423/446; 264/1.32; 264/2.5; 264/297.8; 264/334

(57) ABSTRACT

A method for producing a preferably optical polycrystalline diamond element is provided. A substrate having a surface which is complementary to said element is molded and is coated by means of diamond deposition. The diamond element is then removed from the mold. The diamond element is finished either before or after being removed from the mold. The substrate is machine cut in order to form the complementary molded product having at least one spherical surface, whereupon it is covered with a polycrystalline diamond by chemical vapor deposition (CVD).

The invention relates to a method for producing an element of polycrystalline diamond, wherein a substrate is molded with a surface complementary to a surface of the element, this molded surface is then coated by diamond deposition, and the element formed of diamond is subsequently removed from the mold, and can be finish processed before or after removal from the mold.

The production of structured diamond surfaces by molding are already known. Diamond is deposited on a structured substrate and removal from the mold follows thereafter. Etching techniques are used for structuring the substrate formed of silicon. Thus it is known to be possible to mold so-called moth's eye structures by anisotropic etching of silicon (V. Ralchenko, I. Vlasov, V. Konov, A. Khomich, L. Schirone, G, Sotgiu, A. V. Baranov; Proc. of the ADC/FCT'99; Editors: M. Yoshikawa et al., (AIST-Tsukuba Research Center, Tsukuba, Japan, 1999).

The production of larger spherical surfaces by this anisotropic etching is not possible, due to removal of material at different rates in different crystallographic directions. In practice, structures can thereby be produced whose dimensions are, for example, in the region of tenths of millimeters.

It is also already known to form cup-shaped etching pits in a silicon substrate. Then, for example, a lens array can be produced from a thermoplastic material by molding (W. Menz, J. Mohr, “Mikrosystemtechnik for Ingenieure” [Microsystem Technique for Engineers] 1997, pages 207-209). Here also, the individual lenses have only a very small diameter, in the tenths of millimeter range. Furthermore, the molding is limited to partial regions of a sphere. Spherical surfaces with a large radius cannot be produced thereby.

The production of elements from diamond is admittedly possible in principle with the above-described techniques. There are, however, considerable limitations with respect to the shape and size of the elements.

The mechanical preparation of diamond surfaces is admittedly known for the production of larger elements from diamond, and spherical surfaces can also be produced thereby, for example for optical lenses. However, this processing is very expensive because of the hardness of the diamond material, and is only possible by means of highly specialized, costly methods.

The object of the present invention is to provide a method for the production of elements from diamond, which can be performed in a comparatively simple and cost-favorable manner, and with which elements, in particular also optical lenses, can be produced which have surfaces of different shapes, and in particular, which can have spherical surfaces with a large radius of curvature.

In order to attain this object, it is proposed that the substrate for forming the complementary molding surface having at least one spherical shape is shaped by cutting, and subsequently polycrystalline diamond is grown over it by means of diamond CVD (chemical vapor deposition).

This method according to the invention makes possible the production of a substrate with molding surfaces made in a manner oriented to use and which can have large surfaces, in particular spherical surfaces with a large radius of curvature. By diamond coating and subsequent removal from the mold, elements can thus be produced from diamond which have dimensions of in the centimeter range. The layer thickness of the diamond coating is as a rule proportioned so that, for example, a depression as the molding surface is completely filled.

The preparation of the molding surface(s) in the substrate can take place by means of a grinding process known in lens grinding, the shaping by cutting being performed in particular by grinding, lapping, and polishing. A conventional, proven method is used here, with which the molding surface(s) can be produced with precision and with high surface quality.

One embodiment of the invention provides that, for the simultaneous production of a plurality of elements, particularly optical lenses in an array, a substrate with a corresponding number of molding surface depressions is provided, and subsequently a coherent diamond coating is carried out which covers the molding surface depressions.

The coherent diamond coating can be further processed to form an array, for example, a lens field, in that the growth side of the coherent diamond layer is polished flat.

On the other hand, plural optical lenses, for example, can also be produced thereby. For this purpose, after removal of the coherent diamond layer from the mold, the layer is segmented in to individual components. The processing of the diamond growth side can take place either before or after the segmenting.

The separation or segmenting of the optical lenses or like elements appropriately takes place by laser cutting. The segmenting can thereby be performed precisely, rapidly, and without tool wear.

Silicon or metal, preferably molybdenum, can be used as the substrate.

Silicon as the substrate has the advantage that extremely smooth, mirror-like surfaces can be produced in the molding surface(s); this has a direct effect on the quality of the surface of, for example, the optical element.

With metal as the substrate, the thermal expansion coefficient, which is substantially higher than that of diamond, can be used for removal from the mold, molybdenum being particularly favorable. Removal from the mold by thermal shock treatment makes possible multiple use of the substrate mold.

Additional embodiments of the invention are set out in the further dependent claims. The invention with its important details is described in detail below with reference to the drawings.

In the drawings:

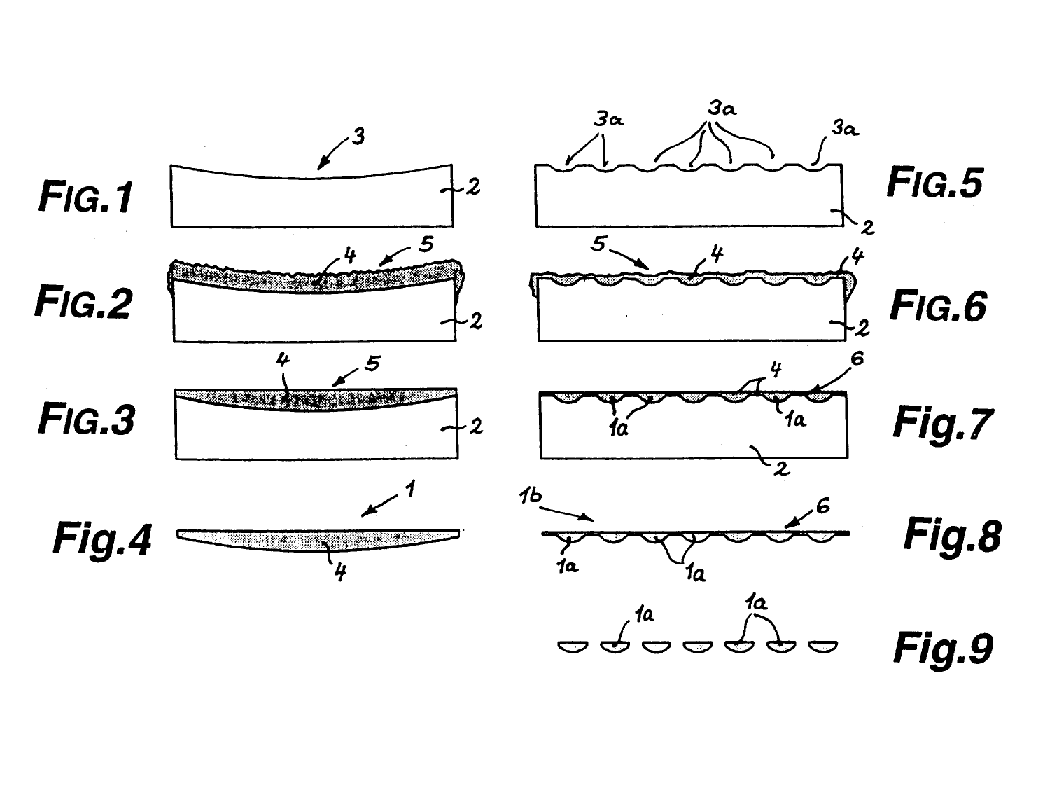

FIGS. 1-4 show the process steps for the production of a plano-convex diamond lens, and

FIGS. 5-9 show the process steps for the simultaneous production of numerous individual diamond lenses.

FIGS. 1-4 show the individual process steps for the production of a plano-convex diamond lens 1. Use is made there of a molding technique in which a substrate 2 forms a mold, the molding surface 3 of which is coated with diamond, and this coating, after a processing step, is separated from the substrate 2 in a process of removal from the mold.

FIG. 1 shows the substrate 2, into the surface of which a molding surface 3 is produced by cutting. In the preferred embodiment shown, a concave molding surface is provided, in order to form the complementary convex side on the element to be produced, which is a plano-convex lens in the preferred embodiment.

The formation of the molding surface 3 in the substrate 2 takes place by cutting, for which the grinding process known in lens grinding can be used. To obtain a high surface quality with the least roughness, further special grinding processes such as lapping and/or polishing of the surface can follow after the shaping of the molding surface 3.

The substrate can be formed of silicon, or else of a metal, preferably molybdenum.

After the preparation of the spherical depression as the molding surface 3, a CVD diamond layer 4 is grown over the substrate, as shown in FIG. 2. The layer thickness is here so proportioned that the spherical depression or the like molding surface is completely filled.

In the embodiment example, the growth side 5 is polished flat according to FIG. 3, in order to provide a plano-convex diamond lens, before removal from the mold. It should be mentioned here that the shaping of the growth side 5 can also take place so that a convex or concave surface is created, in order to form a biconvex or concave-convex lens. For a plano-concave diamond lens, it is also possible to form the molding surface 3 in the substrate complementary to the concave lens side, in that the surface of the substrate 2 is given a convex shape.

After the finishing processing of the diamond lens 1 according to FIG. 3, there follows the removal from the mold and therewith separation of the diamond lens from the substrate 2. This can take place by dissolving the substrate 2 in acid or lye. Removal from the mold can take place by etching away, particularly when silicon is used as the substrate,

If metal is used as the substrate, the high expansion coefficient of the metal substrate relative to diamond can be used for the process of removal from the mold. This can take place during the cooling phase after the end of the CVD coating, where the diamond layer is released, maintaining its shape, from the substrate 2. The structured substrate 2 can be used multiple times in this case.

FIGS. 5-9 shows with process steps for simultaneous production of plural individual lenses 1a (FIG. 9) or of a lens array 1b according to FIG. 8.

As can be seen in FIG. 5, the substrate 2 has on its molding side, a number of molding surfaces 3a corresponding to the number of lenses to be produced. Only one row of mold surfaces can be distinguished, due to the sectional view, although for the formation of a lens array, for example, plural mold rows are provided next to each other. The further course of the process according to FIGS. 6 and 7 corresponds to the course of the process described using FIGS. 2 and 3. According to FIG. 7, a coherent diamond layer 6 with plural plano-convex diamond lenses 1a is available, covering the individual molding surfaces 3a. This diamond layer 6 forms a lens array, as shown in FIG. 8, after removal from the mold.

In the case that individual lenses are to be produced, the continuous lens field can be segmented into individual lenses 1a, as shown in FIG. 9. Preferably, this separation is followed by laser cutting.

The shaping of the growth side of the diamond layer takes place in the preferred embodiment while it is still connected to the substrate. However, it is also possible for this shaping to be performed only after removal from the mold.

The process according to the invention is particularly suitable for the production of optical lenses which can have, according to requirements, a diameter in the millimeter region, for example, a diameter of three millimeters. Such optical elements of diamond can also be used in aggressive environments, since they are scratchproof, chemically resistant, temperature stable, and transparent over a wide band. Examples of applications are coupling-out optics for optical fibers, particularly in the IR region, robust focusing lenses for high power lasers, particularly for use in material processing, or scratch-proof lenses for microscope objectives. Apart from such optical elements, other elements, having at least one spherical surface, can be produced from diamond, for example wear-resistant sensing head tips which can be used for the thickness measurement of moving objects (e.g., strips, foils, rotary parts), and which have a correspondingly long lifetime due to their material properties.

1. Method for the production of an element (1, 1a, 1b) from polycrystalline diamond (4), in which process a molding surface on a substrate (2) is shaped with a surface complementary to a surface of the element, the molding surface (3, 3a) is then coated by diamond deposition and subsequently the element formed of diamond is removed from the mold, and is finish processed before and/or after removal from the mold, wherein the substrate (2) is shaped by cutting in order to form the complementary molding surface (3, 3a) to have at least one spherical surface, and polycrystalline diamond (4) is subsequently grown over it by diamond-chemical vapor deposition (CVD).

2. Method according to claim 1, wherein the at least one spherical molding surface (3, 3a) of the substrate (2) is formed grinding processes of a type used in lens grinding, and that the shaping by cutting is performed by grinding, lapping, and polishing.

3. Method according to claim 1 or 2, wherein silicon is used as the substrate (2).

4. Method according to claim 1 or 2, wherein metal, preferably molybdenum, is used as the substrate (2).

5. Method according to one of claims 1-4, wherein for the simultaneous production of plural elements (1a), particularly optical lenses (an array), a substrate (2) is provided with a corresponding number of molding surface depressions (3a), and subsequently a coherent diamond coating covering the molding surface depressions is performed.

6. Method according to claims 5, wherein after the coherent diamond layer (6) has been removed from the mold, the layer is segmented into individual components.

7. Method according to claim 5 or 6, wherein the segmented individual components are shaped, preferably polished flat, on a growth side (5) after having been removed from the mold.

8. Method according to claim 5, wherein the coherent diamond layer (6) is shaped, preferably polished flat, on a growth side (5) after having been removed from the mold.

9. Method according to one of claims 5-8, wherein the separation or segmenting of the optical lenses (1, 1a) takes place by laser cutting.

10. Method according to one of claims 1-9, wherein the removal from the mold takes place by thermal shock treatment.

11. Method according to one of claims 1-10, wherein the removal from the mold takes place by dissolving the substrate (2) in acid or lye.

12. A component with at least one spherical surface, produced according to the method according to one or more of claims 1-11.

13. Component according to claim 12, wherein the component is a part of a mechanical measuring tracing tip, or an optical lens, part of a microscope optics, a laser optics, a coupling-out optics for optical fibers, or the like.

14. Component according to claim 12 or 13, wherein the component is formed of a diamond plate with a surface having a field (array) of optical lenses.
